(19) United States
(12) Patent Application Publication
(10) Pub. No.: US 2015/0091804 A1
(43) Pub. Date: Apr. 2, 2015

(54) TECHNIQUE FOR IMPROVING OPERABILITY IN SWITCHING CHARACTER TYPES IN SOFTWARE KEYBOARD

(71) Applicant: Konica Minolta, Inc., Chiyoda-ku (JP)

(72) Inventor: Hiroyasu ITO, Okazaki-shi (JP)

(21) Appl. No.: 14/497,578

(22) Filed: Sep. 26, 2014

(30) Foreign Application Priority Data
Oct. 2, 2013 (JP) 2013-207354

(51) Int. Cl. G06F 3/023

(52) U.S. Cl. CPC G06F 3/023; G06F 3/0233
USPC 345/168

(57) ABSTRACT

An input device with improved operability in switching character types is provided. The input device includes a display unit configured to display an image of each key that constitutes a keyboard and is labeled with information for identifying the operation modes, and a touch panel configured to accept an input operation on an image of the keyboard. Each key is set so as to accept an input in accordance with an operation mode of the input device. The input device further includes a controller configured to, if an operation on the touch panel to indicate a predetermined direction is accepted, select an operation mode in accordance with the predetermined direction from the operation modes identified by the information labeled on the each key and allow the display unit to display the keyboard corresponding to the selected operation mode.

This application is based on Japanese Patent Application No. 2013-207354 filed with the Japan Patent Office on Oct. 2, 2013, the entire content of which is hereby incorporated by reference.

### BACKGROUND OF THE INVENTION

1. Field of the Invention

The present disclosure relates to an input interface of equipment, and more particularly to control on an input interface for accepting touch operation.

2. Description of the Related Art

MFPs (Multi-Functional Peripherals), copiers, printers, and other equipment are becoming more and more versatile. In the case of MFPs, for example, users have more opportunities to input not only selection of operation modes but also various kinds of characters to input, for example, email addresses during scan-to-send, FTP (File Transfer Protocol) addresses, and URLs (Uniform Resource Locators) using the web browser function.

Regarding the character input, for example, Japanese Laid-Open Patent Publication No. 2012-181879 (Document 1) discloses a “software key input method with good operability with reduced screen space” (see Abstract).

Japanese Laid-Open Patent Publication No. 2011-118507 (Document 2) discloses a technique for “improving the efficiency in text input by allowing input of multilingual characters without performing an operation of changing the kinds of characters that can be input” (see Abstract).

Japanese Laid-Open Patent Publication No. 2011-065532 (Document 3) discloses a technique “allowing input of desired letters of alphabet promptly without switching an upper case mode and a lower case mode” (see Abstract).

According to the technique disclosed in Document 1, input character types are switched by flick operation irrelevant of screen display, and it is difficult to grasp the result of the switching operation. The technique disclosed in Document 2 improves the operation method to select a single character but cannot be applied to the operation of successively switching character types. The technique disclosed in Document 3 distinguishes between upper cases and lower cases by input patterns but cannot be applied to characters that do not fit the input patterns. There is a need for a technique that improves the operability in switching character types in software keyboards.

### SUMMARY OF THE INVENTION

According to an embodiment, an input device having a plurality of operation modes includes a display unit configured to display an image of each key that constitutes a keyboard and is labeled with information for identifying the operation modes, and a touch panel configured to accept an input operation on an image of the keyboard. Each key is set so as to accept an input in accordance with an operation mode of the input device. The input device further includes a controller configured to, when an operation on the touch panel to indicate a predetermined direction is accepted, select an operation mode in accordance with the predetermined direction from the operation modes identified by the information labeled on each key and allow the display unit to display the keyboard corresponding to the selected operation mode.

According to another embodiment, an information processing apparatus including an input device recited above is provided.

According to another aspect, a method for controlling an input device including a touch panel and having a plurality of operation modes is provided. The method includes: displaying an image of each key that constitutes a keyboard and is labeled with information for identifying the operation modes; and accepting an input operation on an image of the keyboard. Each key is set so as to accept an input in accordance with an operation mode of the input device. The method further includes: if an operation on the touch panel to indicate a predetermined direction is accepted, selecting an operation mode in accordance with the predetermined direction from the operation modes identified by the information labeled on each key and displaying the keyboard corresponding to the selected operation mode.

According to a further embodiment, a non-transitory data recording medium is provided, for storing a program for causing a computer to perform a method recited above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a transition of keyboards appearing on an input device 100.

FIG. 2 illustrates a display manner of a software key 200.

FIG. 3 illustrates details of a software keyboard appearing on the touch panel 300 of the input device 100.

FIG. 4 illustrates a manner in which display manners of the software keyboard 310 are switched.

FIG. 5 illustrates a manner in which the display face is switched through an operation of turning a cubic key down on the input device 100.

FIG. 6 is a block diagram illustrating a configuration of functions implemented by the input device 100.

FIG. 7 is a flowchart illustrating part of processing performed by the input device 100.

FIG. 8 is a diagram illustrating part of processing in a gesture determination process 800.

FIG. 9 is a diagram illustrating a table 900 for control of identifying a key input operation.

FIG. 10 illustrates a display manner of a key 1000.

FIG. 11 illustrates a state transition of the input device 100.

FIG. 12 is a diagram illustrating data for defining switching of software keyboards appearing on the touch panel 300.

FIG. 13 is a diagram illustrating a changing state in which a software key 1310 is rotated and displayed.

FIG. 14 illustrates a display manner in the touch panel 300.

FIG. 15 is a diagram illustrating settings in a case where a character input operation is made by a keyboard in the input device 100.

FIG. 16 is a diagram that defines settings of display of destination selection in an MFP.

FIG. 17 illustrates another manner of switching of display of a software key 1700.

FIG. 18 illustrates another manner of a software key 1800 appearing on the input device 100.

FIG. 19 illustrates a manner in which a software key appearing on the touch panel 300 of the input device 100 is circular.

FIG. 20 is a block diagram illustrating the hardware configuration of the input device 100.

### DESCRIPTION OF THE PREFERRED EMBODIMENTS

Embodiments of the present invention will be described below with reference to the figures. In the following description, the same parts are denoted with the same reference signs. Their names and the functions are also the same, and a detail description thereof will not be repeated.

[Technical Concept]

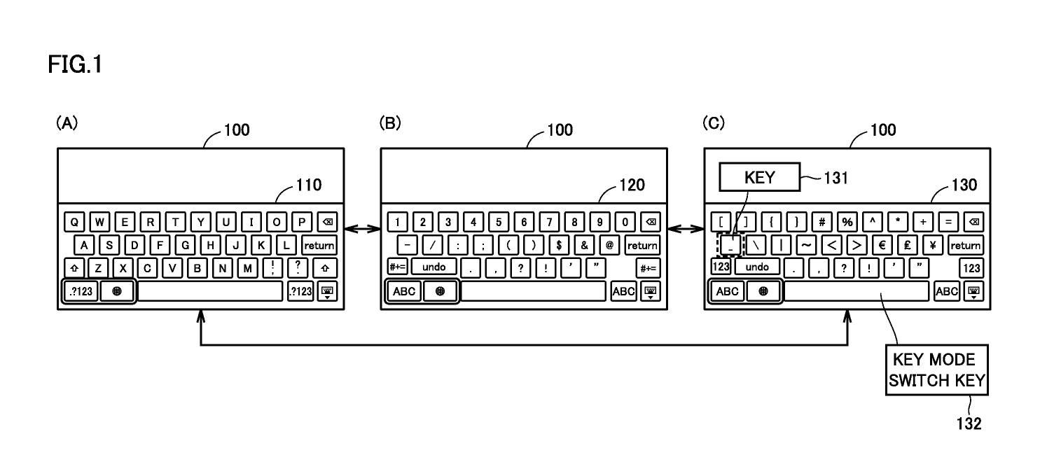

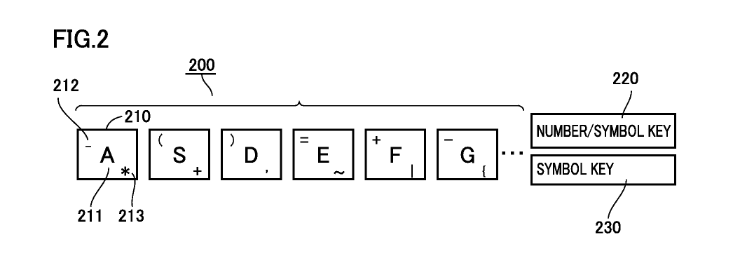

Referring to FIG. 1 and FIG. 2, an input device 100 that the technical concept of the present embodiment is not yet applied to will be described. FIG. 1 illustrates a transition of keyboards appearing on the input device 100. Although the input device 100 is included in an MFP (Multi-Functional Peripheral) by way of example in the present embodiment, the application of the input device 100 is not limited to an MFP. For example, the input device can be applied to tablet terminals, notebook computers, smart phones, and other information processing apparatuses that have touch panels.

In FIG. 1, in the state (A), the input device 100 displays a software keyboard 110. In one aspect, the software keyboard 110 is a keyboard for accepting input of letters of alphabet. In the state (B), in another aspect, the input device 100 displays a software keyboard 120. The software keyboard 120 is, for example, a keyboard for accepting input of numbers or symbols. In the state (C), the input device 100 displays a software keyboard 130. In one aspect, the software keyboard 130 is a keyboard for accepting input of arithmetic and other symbols that are not included in the software keyboard 120.

In the state (C), the user touches a key 131 to enter a key “-” of interest. When the user presses a key 132 to which a function for switching key modes is allocated, the input device 100 switches the display of the software keyboard 130 to the software keyboard 110 (the state (A)).

The switching between the state (A) and the state (B) and the switching between the state (B) and the state (C) are also done similarly through a touch operation by the user.

In the configuration described above, the user may successively input characters while switching input modes of keyboards in accordance with characters to be input. In this case, if a character key of interest does not exist in the keyboard at that time, the user has to see if the character key of interest exists in the software keyboard appearing by switching every time the operation of successively switching input modes and the switching are done.

More specifically, until a key labeled with a character of interest is found, the user performs a series of operations: (step 1) switching input types of software keyboards (step 2) looking for a key of interest from the entire software keyboard (step 3) if the key of interest is not found, switching input types of software keyboards again (step 4) looking for the key of interest again if the key of interest is found, touching the key. In this case, the number of steps of the user's finger operation increases until the key of interest is found, and the user moves the eyes in a wider range, so that the operation takes time and the input efficiency may be reduced.

The technical concept according to the present embodiment described later may reduce unnecessary operations and movement of eyes during input using software keyboards and improve the efficiency of input operation.

For example, a case where characters are input using a software keyboard in the QWETRY arrangement will be examined. For example, to input characters km_{—}1@abc.com, the user enters alphabet→number→symbol (for example, @)→alphabet→symbol (.)→alphabet. This requires the user to press the switch key at an end of the screen in the software keyboard multiple times during key switching operation and look for a character key of interest. The moving distance of the finger/eyes during input operation may be long.

Although the operation on the switch button in the software keyboard of interest can be performed in a single action, the user may not remember which software keyboard includes the key of interest, and the software keyboard appearing at that time may not include the key of interest. The user then may make an unnecessary input operation on the software keyboard. The reason for this lies in that the user cannot easily determine the procedure for displaying the key of interest from the display manner of the software keyboard at present. For example, although inputting characters km_{—}1@abc.com requires only five actions at the shortest, if not wrong, the user may perform an operation for switching software keyboards seven times.

Referring to FIG. 2, a display manner of keys in another aspect will be described. FIG. 2 illustrates a display manner of a software key 200.

In one aspect, the software key 200 displays a plurality of keys. The keys include a key represented by a rectangle, for example, such as a key 210.

The key 210 displays a character 211 and symbols 212, 213 in the rectangular region. The character 211 is, for example, a predetermined letter of alphabet such as “A”. The symbols 212, 213 are symbols (for example, “-”, “*”) input by touching the key 210 when the key input mode is a symbol input mode.

With such a configuration, the user has to operate a keyboard switch key (for example, a key 220 or a key 230) at an end of the screen. This makes the movement of eyes or fingers longer during operation. For example, when there are three kinds of character input modes of keyboard, three characters or symbols are displayed, and it is difficult for the user to understand which character type key should be selected to enable a desired character input. A technique that facilitates input of characters or symbols is therefore required.

[Display Manner of Soft Key]

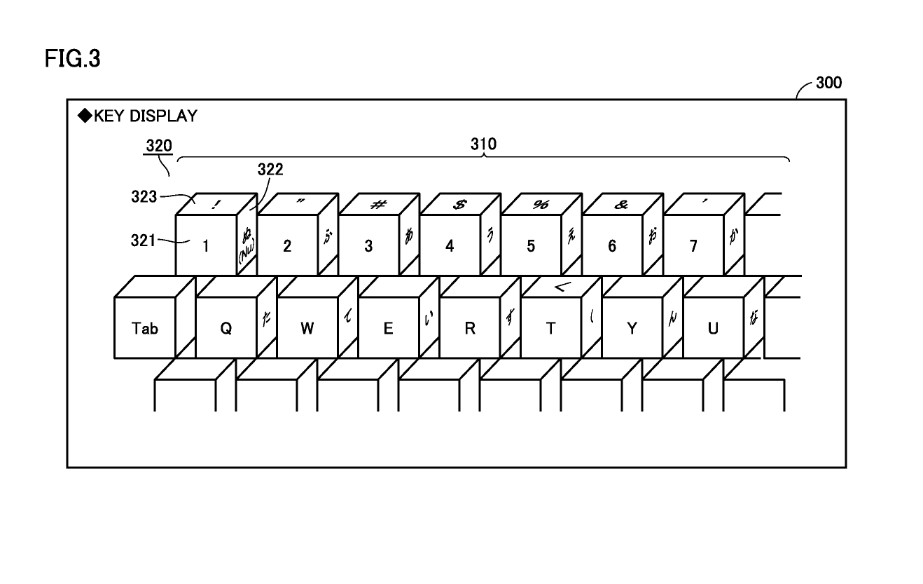

Referring to FIG. 3, a display manner of keys in the input device 100 according to the present embodiment will be further described. FIG. 3 illustrates details of the software keyboard appearing on the touch panel 300 of the input device 100.

In one aspect, the touch panel 300 displays a software keyboard 310. The software keyboard 310 includes a plurality of keys. The keys include a key 320. The key 320 is displayed, for example, as a cubic image. More specifically, the key 320 is displayed in such an arrangement in that three faces of the cube are displayed toward the front. The key 320 includes faces 321, 322, 323. The face 321 displays a number (1). The face 322 displays a hiragana (NU). The face 323 displays a symbol (!).

The software keyboard 310 shown in FIG. 3 is configured such that the key 320 accepts input of the number (1) displayed on the face 321 (active) when it is touched. In another aspect, the software keyboard 310 may be changed to accept input of hiragana (the face 322) or symbol (the face 323) by changing the display thereon. For example, when the face 322 is displayed at the position of the face 321 (becomes active), the input device accepts input of hiragana “NU” when detecting a touch on the face 322.

[Switching Left and Right]

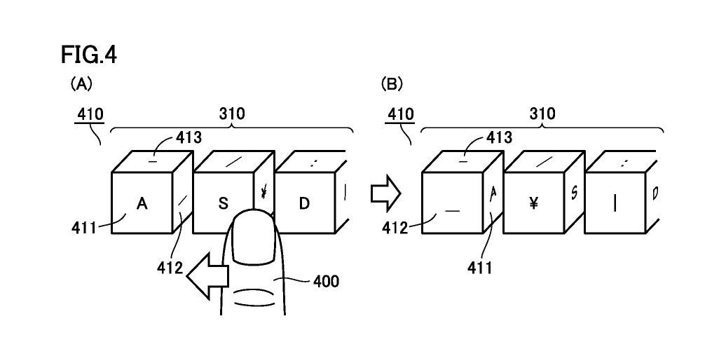

Referring to FIG. 4, an operation example in the input device 100 according to the present embodiment will be described. FIG. 4 illustrates a manner in which display manners of the software keyboard 310 are switched.

As shown in the state (A), in one aspect, the software keyboard 310 displays a plurality of keys set so as to accept input of letters of alphabet. For example, the software keyboard 310 includes a key 410. The key 410 includes faces 411, 412, 413. The face 411 is labeled with a letter of alphabet (A). The face 412 is labeled with a symbol (_). The face 413 is labeled with a symbol (_).

In one aspect, the user of the input device 100 puts the finger 400 on the touch surface of the software keyboard 310 appearing on the touch panel 300 and performs a flick operation so as to roll a dice to the left in the arrow direction. The touch panel 300 then provides animation display as if a dice rolls for the display of the software keyboard 310 and switches the display manner of the software keyboard 310.

More specifically, as shown in the state (B), the software keyboard 310 displays the face 412 on the front. The face 411 is displayed on the side of the key 410. That is, the face 411 and the face 412 switch places. As a result, a touch on the key 410 is detected as an operation for inputting the symbol (_) displayed on the face 412.

The face 413 is displayed on the top of the key 410 both before and after the flick operation. The flick operation with the finger 400 is a leftward operation and switches the positions of the faces displayed left and right.

[Switching Up and Down]

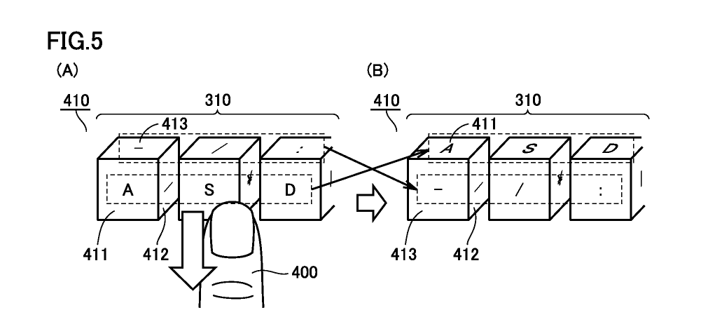

Referring to FIG. 5, the operation of the input device 100 according to the present embodiment will be further described. FIG. 5 illustrates a manner in which the display surface is switched through an operation of turning a cubic key down on the input device 100.

As shown in the state (A), in one aspect, the touch panel 300 displays the software keyboard 310. More specifically, the software keyboard 310 is displayed so as to accept input of letters of alphabet (see the state (A) in FIG. 1). A letter of alphabet (A, S, D) is displayed on the front of each key. When the user of the input device 100 puts the finger 400 on the touch panel 300 and performs a flick operation as if to roll a dice down in the arrow direction, the touch panel 300 displays animation like a dice is rolled. As a result, the display content on the front of the key and the display content on the top are switched.

More specifically, as shown in the state (B), the touch panel 300 switches display positions such that the symbol (“-”, “/”, “:”) that has been displayed on the top of each cubic key is displayed on the front. For example, the face 411 of the key 410 that has been displayed on the front in the state (A) is displayed on the top in the state (B). Conversely, the face 413 that has been displayed on the top is displayed on the front in the state (B). The input device 100 thus accepts, as the software keyboard 310, input of symbols. As described above, animation like a dice rolled down is displayed, and the entire keyboard changes from the state in which numeric/alphabetical keys are displayed on the front to the state in which symbol keys are displayed on the front.

[Functional Configuration of Input Device]

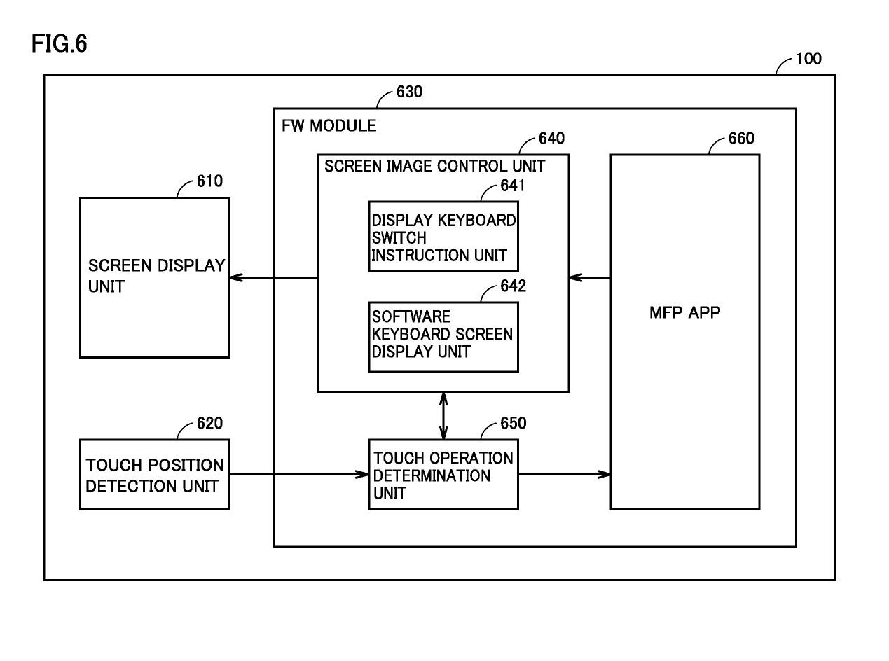

Referring to FIG. 6, the configuration of the input device 100 according to the present embodiment will be described. FIG. 6 is a block diagram illustrating a configuration of functions implemented by the input device 100. The input device 100 includes a screen display unit 610, a touch position detection unit 620, and a firmware (FW) module 630. The firmware module 630 includes a screen image control unit 640, a touch operation determination unit 650, and an MFP app 660. The screen image control unit 640 includes a display keyboard switch instruction unit 641 and a software keyboard screen display unit 642.

The screen display unit 610 displays a software keyboard under the control of the screen image control unit 640. In one aspect, the screen display unit 610 is implemented as touch panel 300.

The touch position detection unit 620 detects the position where a touch operation is performed, based on the touch operation on the screen display unit 610. The detected position includes a coordinate value, the amount of movement (the number of dots) in swipe operation, and the like.

The firmware module 630 controls the operation of the input device 100. More specifically, in the firmware module 630, the screen image control unit 640 displays a software keyboard on the screen display unit 610 in accordance with an instruction from the MFP app 660 or switches display manners of the software keyboard. More specifically, the display keyboard switch instruction unit 641 detects an instruction to switch display manners of the software keyboard as shown in FIG. 1 in accordance with an instruction form the MFP app 660. The software keyboard screen display unit 642 generates an image to be displayed on the screen display unit 610 in response to the instruction.

The touch operation determination unit 650 specifies the content of the touch operation made on the touch panel 300 of the input device 100, based on output from the touch position detection unit 620 and reference data retained in the input device 100 in advance. The content of the touch operation will be described later.

The MFP app 660 defines the operation of the MFP having the input device 100. The operation of the MFP can be easily understood by those skilled in the art and therefore the details of the operation are not described.

[Control Structure]

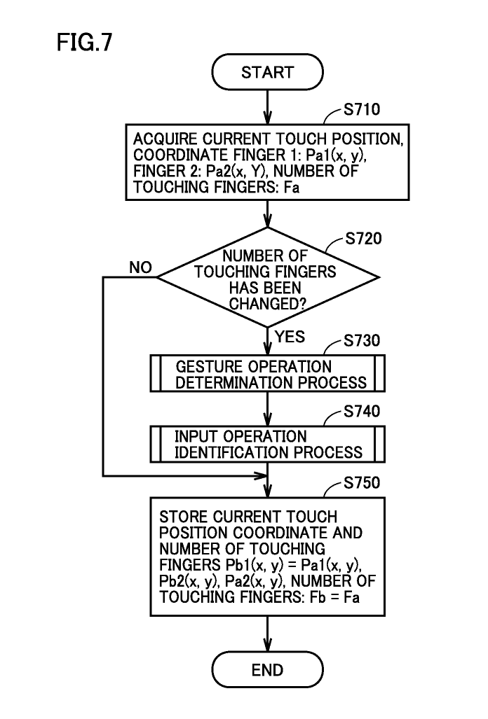

Referring to FIG. 7, the control structure of the input device 100 according to the present embodiment will be described. FIG. 7 is a flowchart illustrating part of processing performed by the input device 100. In one aspect, the process shown in FIG. 7 is implemented by a processor in the input device 100 executes an instruction. In another aspect, the process shown in FIG. 7 may be implemented by a combination of circuit elements configured to execute each process.

In step S710, the firmware module 630 acquires the coordinate value of the current touch position based on the output from the touch position detection unit 620. The touch position coordinate value includes, for example, a first coordinate value Pa1 (x, y) of the finger 400, a second finger coordinate value Pa2 (x, y), and the number of touching fingers (the number of fingers touching the touch panel 300) Fa.

In step S720, the firmware module 630 determines whether the number of fingers touching the touch panel 300 has been changed, based on the touch position coordinate value acquired in step S710. If it is determined that the number of touching fingers has been changed (YES in step S720), the firmware module 630 switches the control to step S730. If not (NO in step S720), the firmware module 630 switches the control to step S750.

In step S730, the firmware module 630 performs a gesture operation determination process. The details of this process will be described later.

In step S740, the firmware module 630 performs an input operation identification process. The details of this process will be described later.

In step S750, the firmware module 630 stores the current touch position coordinate and the number of touching fingers into a memory (not shown) of the input device 100. More specifically, the input device 100 retains the following values.

Pb1(x,y)=Pa1(x,y)

Pb2(x,y),Pa2(x,y)

The number of touching fingers: Fb=Fa

Subsequently, the process ends.

[Gesture Determination]

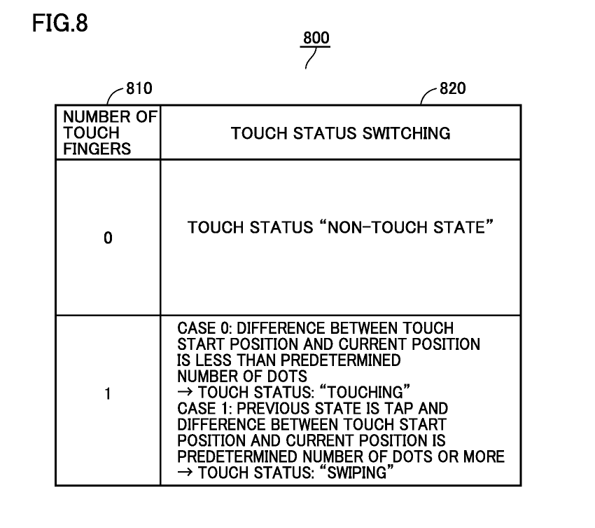

Referring to FIG. 8, a gesture determination process 800 in the input device 100 according to the present embodiment will be described. FIG. 8 is a diagram illustrating part of processing of the gesture determination process 800.

The gesture determination process 800 is defined by the number of touch fingers 810 and touch status switching 820. The number of touch fingers 810 defines zero or one as the number of fingers touching the touch panel 300. For example, when the number of touch fingers 810 is “zero”, the touch status is set in “non-touch state” (touch status switching 820).

When the number of touch fingers 810 is “one”, the statuses are individually defined depending on the state at that time. For example, in a case 0, the difference between the touch start position and the current position is less than a predetermined number of dots. In this case, the touch status of the touch panel 300 is set “touching”. In a case 1, the previous state is a tap state and the difference between the touch start position and the current position is equal to or greater than the predetermined number of dots. In this case, the touch status is set “swiping”.

[Identification of Key Input Operation]

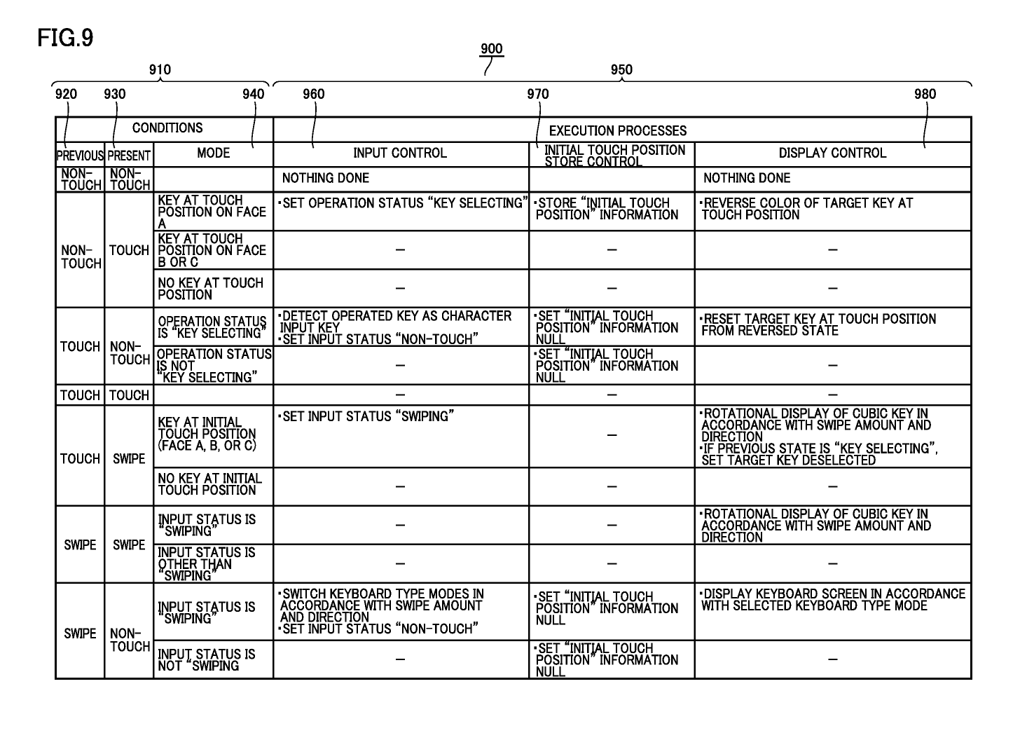

Referring to FIG. 9, control of identifying a key input operation in the input device 100 according to the present embodiment will be described. FIG. 9 is a diagram illustrating a table 900 for control of identifying a key input operation. The table 900 defines conditions 910 and execution processes 950. The conditions 910 include a previous state 920, a present state 930, and a mode 940. The execution processes 950 include input control 960, initial touch position storage control 970, and display control 980.

The previous state 920 represents the previous state before the current operation on the input device 100 is performed. The present state 930 represents the state of the current operation on the input device 100. The mode 940 represents the state of touch operation on the touch panel 300.

For example, when the previous state 920 is “touch”, the present state 930 is “swipe”, and the mode 940 is “there is a key at the initial touch position (A or B or C face)”, the input control 960 is defined as “input status is set “swiping”. In this case, “rotational display of a cubic key in accordance with swipe amount and direction” is defined as the display control 980. It is further defined that the target key is deselected if the previous state is “selecting key”.

More specifically, when the user initially touches the touch panel 300, the touch operation determination unit 650 detects a touch operation and detects that the state of the touch panel 300 changes from non-touch to touch in the first processing. Here, if the touched place is the front (for example, face A) of the software keyboard image, the touch operation determination unit 650 determines that the character, number, or symbol allocated on the front is pressed, and outputs the result of the determination to the screen image control unit 640. In the screen image control unit 640, the software keyboard screen display unit 642 reverses the display of that face and displays the reversed image on the screen display unit 610. The user thus can recognize that the touch operation on the front face (for example, face A) is accepted by the input device 100.

When a release operation is performed from the touch operation, the input device 100 retains information that the character, number, or symbol allocated to the face concerned is selected and input as a corresponding key-selected state.

When the touch operation on the face concerned is removed and the user's finger is released in the subsequent routine process, here, touch changes to non-touch and the operation status is “key selecting”. The touch operation determination unit 650 then notifies the MFP app 660 of the character, number, or symbol allocated to the face selected by the user. MFP app 660 then detects that an input operation on the touched surface is performed in the touch panel 300, and performs a process in accordance with the detection result.

[Key Display Manner]

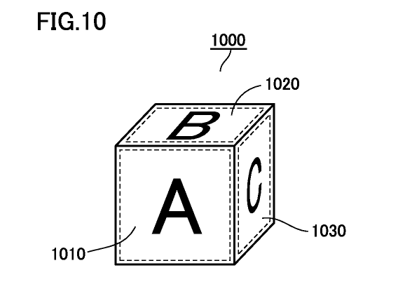

Referring to FIG. 10, a key appearing on the display device 100 according to the present embodiment will be described. FIG. 10 illustrates a display manner of a key 1000.

In one aspect, the key 1000 includes three faces, namely, a face A 1010, a face B 1020, and a face C 1030. The face A 1010 is a face active so as to accept input through a touch operation. The face B 1020 and the face C 1030 are not active and therefore do not accept input of the character or symbol allocated to those faces even when touched by the user's finger. In another aspect, when the face B 1020 is displayed at the current position of the face A 1010, the face B 1020 accepts input of the allocated character, number, or symbol.

[State Transition of Input Device 100]

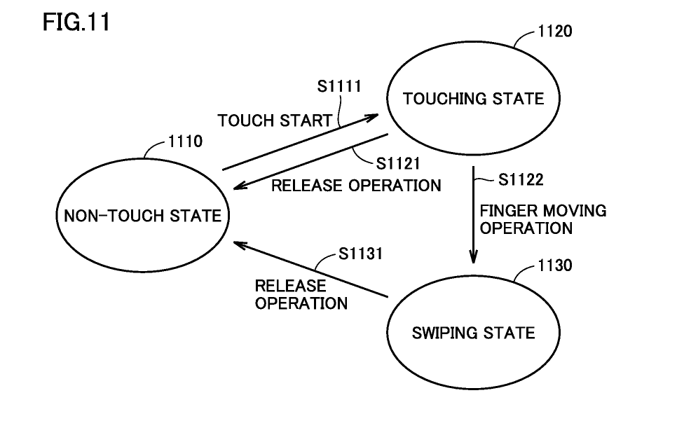

Referring to FIG. 11, switching states of the input device 100 according to the present embodiment will be described. FIG. 11 illustrates a state transition of the input device 100.

The states of the input device 100 include a non-touch state 1110, a touching state 1120, and a swiping state 1130. When the user starts a touch operation on the touch panel 300 (step S1111), the state of the touch panel 300 makes a transition from the non-touch state 1110 to the touching state 1120. Subsequently when the user releases (that is, lift) the finger from the touch panel 300 (step S1121), the state of the touch panel 300 makes a transition from the touching state 1120 to the non-touch state 1110.

When the user makes a finger moving operation in the touching state 1120 (step S1122), the state of the touch panel 300 makes a transition from the touching state 1120 to the swiping state 1130.

[Data Structure]

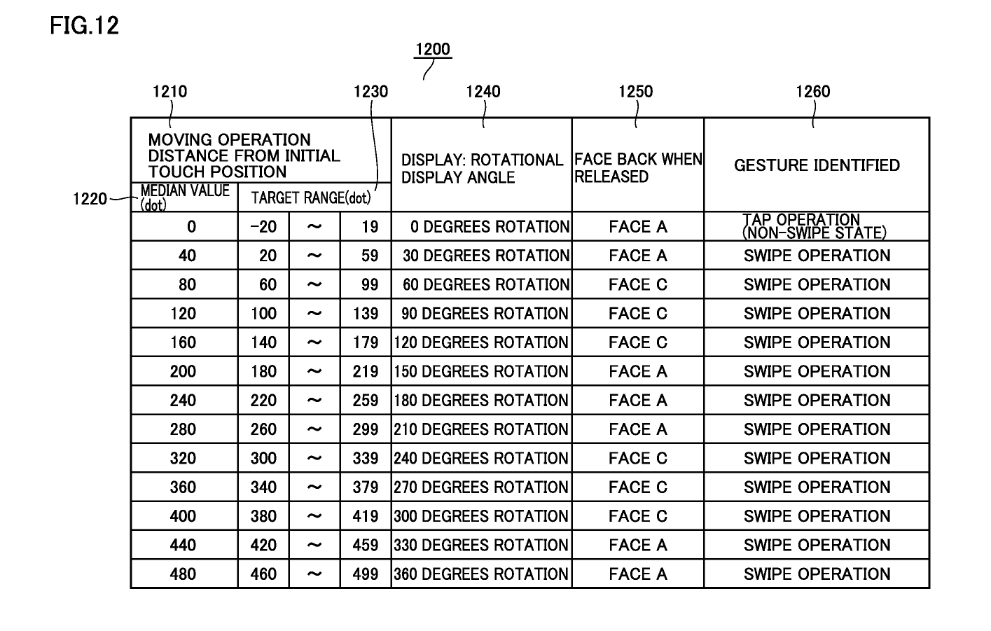

Referring to FIG. 12, the operation of the input device 100 according to the present embodiment will be further described. FIG. 12 is a diagram illustrating data for defining switching of software keyboards appearing on the touch panel 300. The input device 100 performs animation display in accordance with the direction of the swipe operation on the touch panel 300. For example, when the user performs a swipe operation in the lateral direction, the input device 100 displays animation such that the software keyboard is rotated by a predetermined angle in accordance with the distance of the swipe operation. When the user lifts the finger from the touch panel 300 in this state, the input device 100 displays the input type (for example, character, number, or symbol) defined depending on the angle at that time on the touch panel 300.

More specifically, in one aspect, the input device 100 retains a table 1200. The table 1200 defines animation display of each key included in the software keyboard. The table 1200 includes a moving operation distance 1210 from the initial touch position, a display (rotational display angle) 1240, a face 1250 back when released, and a gesture identified 1260. The moving operation distance 1210 from the initial touch position includes a median value 1220 and a target range 1230.

The median value 1220 and the target range 1230 are defined, for example, by the number of dots. The input device 100 controls animation of each software key displayed on the touch panel 300 based on the settings defined by the table 1200.

For example, when an operation on the touch panel 300 is performed, if the median value 1220 is 40 dots and included in a valid range (20 dots to 59 dots), the display: rotational display angle 1240 is defined as 30-degree rotation, the face 1250 back when released is defined as the face A, and the gesture identified 1260 is identified as “swipe operation”.

[Display Manner of Software Key]

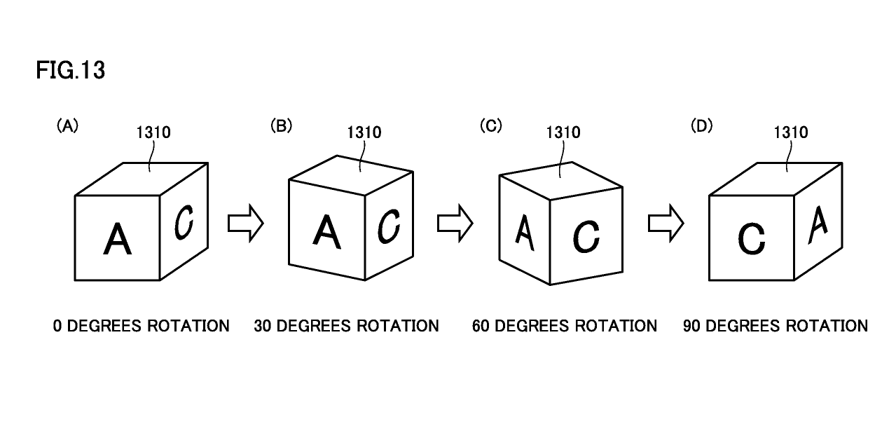

Referring to FIG. 13, a display manner of a software key in the input device 100 according to the present embodiment will be described. FIG. 13 is a diagram illustrating a changing state in which a software key 1310 is rotated and displayed.

The state (A) shows a state in which the software key 1310 is displayed by default. Specifically, the touch panel 300 displays the software key 1310 included in the software keyboard, which is set active so as to accept input of the character, number, or symbol allocated to the face A. In this state, the rotation angle is defined as zero degree.

As shown in the state (B), the software key 1310 rotates 30 degrees depending on the degree of a flick operation. The degree of rotation here is defined in FIG. 12. The axis of center of rotation is, for example, the axis passing through the center of the image of the software key 1310.

As shown in the state (C), the software key 1310 may be displayed in a state in which it is further rotated 60 degrees. When the software key 1310 is thereafter further rotated 90 degrees in total, as shown in the state (D), the front of the software key 1310 is switched to the face C. Here, the side of the software key 1310 is the face A. That is, the left and right faces switch places. Here, the top does not change.

[Other Features]

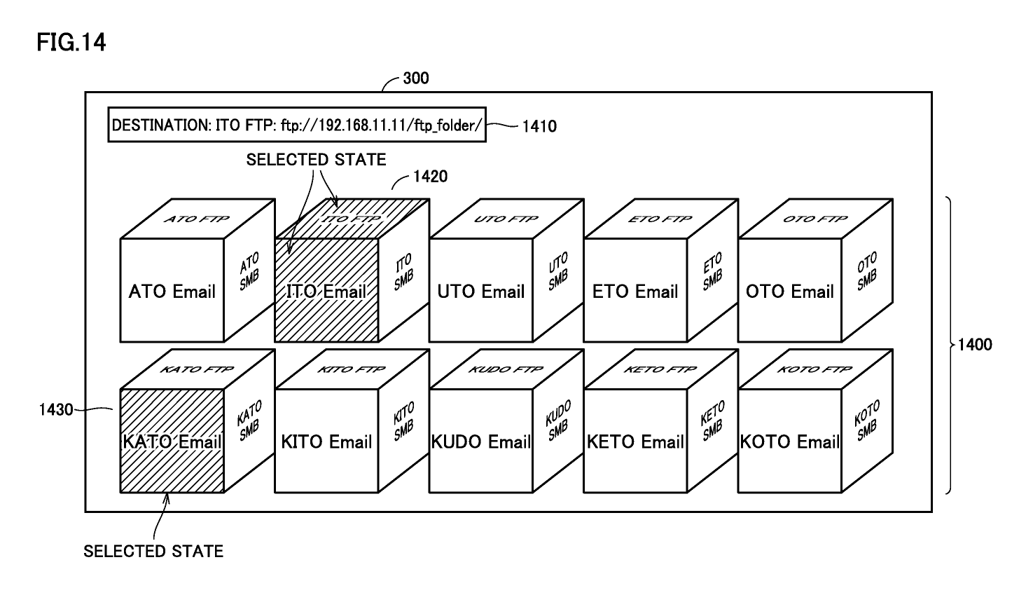

Referring to FIG. 14, the features of the input device 100 according to the present embodiment will be further described. FIG. 14 illustrates a display manner in the touch panel 300. The technical concept of the present embodiment is not limited to the switching between character, number, and symbol inputs. For example, when a plurality of methods for transmitting data are available, the technical concept of the present embodiment can be used to select one of the methods.

More specifically, in another aspect, the input device 100 may display a screen for selecting destinations registered in the MFP on the touch panel 300. The destinations are used for transmitting scanned data from the MFP to another information processing apparatus. Examples of transmission methods include emails, FTP (File Transfer Protocol), SMB (Server Message Block), and others. One or more kinds of addresses can be used. For example, addresses allocated by an Internet service provider, addresses of portable terminals, and other addresses allocated to users for each network service can be used as destinations.

In data transmission, the sender selects a transmission method in accordance with the size of data to be transmitted. For example, when a document file has a large size (large data volume), the user may select FTP with a large transmission capacity. In another aspect, if the document size is small, the user may select an email that allows simultaneous transmission of a message and an attached file (document file). This is because the recipient can be promptly notified of transmission of a document file.

In one aspect, a large document may be transmitted to a plurality of destinations by FTP. If the transmission method initially set in the MFP is email, the sender has to switch the transmission method to FTP. When the sender sends a document to a plurality of destinations, the switching operation may be cumbersome depending on the number of destinations. The technical concept of the present embodiment then allows the user to select a transmission method easily even in such a case.

More specifically, the touch panel 300 displays a destination 1410 and a software key 1400. The software key 1400 includes a plurality of cubic images. The example shown in FIG. 14 shows an aspect in which the user (Kato) of the MFP having the input device 100 transmits data to Ito by FTP. That is, the user (Kato) selects a soft key having his name registered thereon by touching an image 1430 as a sender. The user then selects a key 1420 to select a destination. Here, since the face that the setting for transmission by FTP is allocated to is allocated on the top of the key 1420, the user (Kato) performs a swipe operation from above to below thereby to display the face labeled with Ito FTP on the front. The user selects that face (Ito FTP) in this state thereby to set the destination by the transmission method desired by the user, as shown by a destination 1410.

The user may wish to confirm detail information (for example, the detailed name of the destination, the email address, the FTP address, etc.) again in addition to the destination after selecting the destination. In such a case, the user touches the selected key so that the detail information of the destination shows up on the touch panel 300. The user thus can confirm the detail information even after selecting a destination and a transmission method.

When the technical concept of the input device 100 is used in the transmission as described above, the data structure for touch identification differs from the data structure for use in character input. The difference in data structure will now be described.

[Settings of Input Device 100]

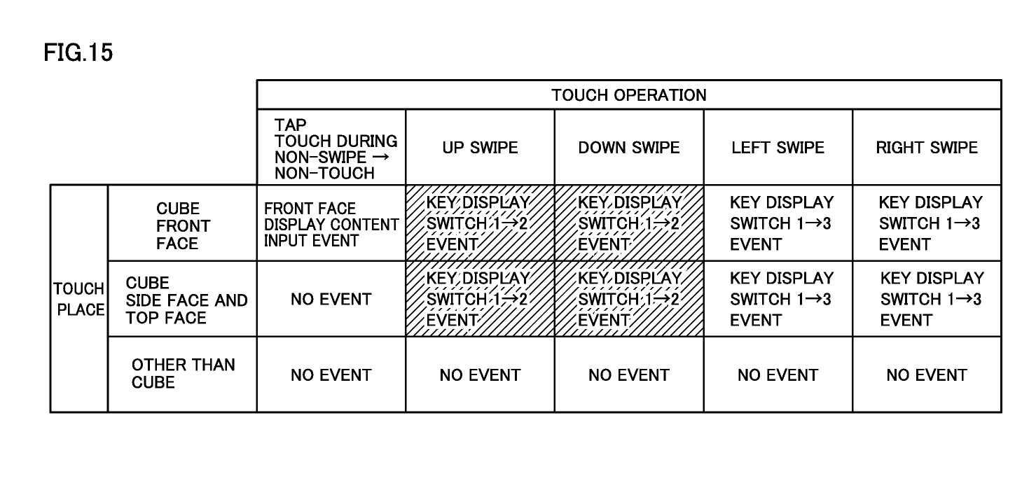

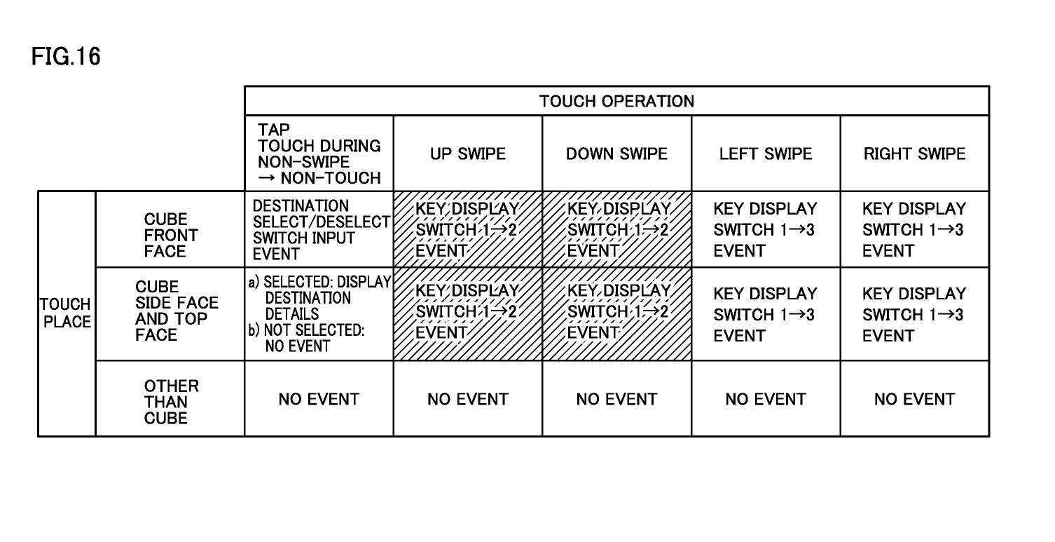

Referring now to FIG. 15 and FIG. 16, the features of the input device 100 according to the present embodiment will be further described. FIG. 15 is a diagram illustrating settings in a case where a character input operation is made by a keyboard in the input device 100. FIG. 16 is a diagram that defines settings of display of destination selection in the MFP.

In FIG. 15, the numeral 1 represents a character key input mode. The numeral 2 represents a number or symbol input mode. The numeral 3 represents a symbol input mode. In FIG. 16, the numeral 1 represents transmission using email. The numeral 2 represents transmission using FTP. The numeral 3 represents transmission using SMB.

As shown at the top of the left column in FIG. 15, when a touch place is “the front face of the cubic”, the operation on the touch panel 300 is “tap”, the state on the touch panel 300 is “not swiping”, and the finger is lifted from the touch panel 300 (touch→non-touch), “front face display content input event” is set to be executed. On the other hand, as shown at the top of the left column in FIG. 16, in the input device 100 of the MFP, “destination select/deselect switch input event” is defined under the same conditions.

The middle of the left column in FIG. 15 and the middle of the left column in FIG. 16 are also different. Such a difference is incorporated into the input device 100, so that the input device 100 according to the present embodiment can be applied to both switching between character, number, or symbol input modes and selection of a transmission method.

[Other Manners]

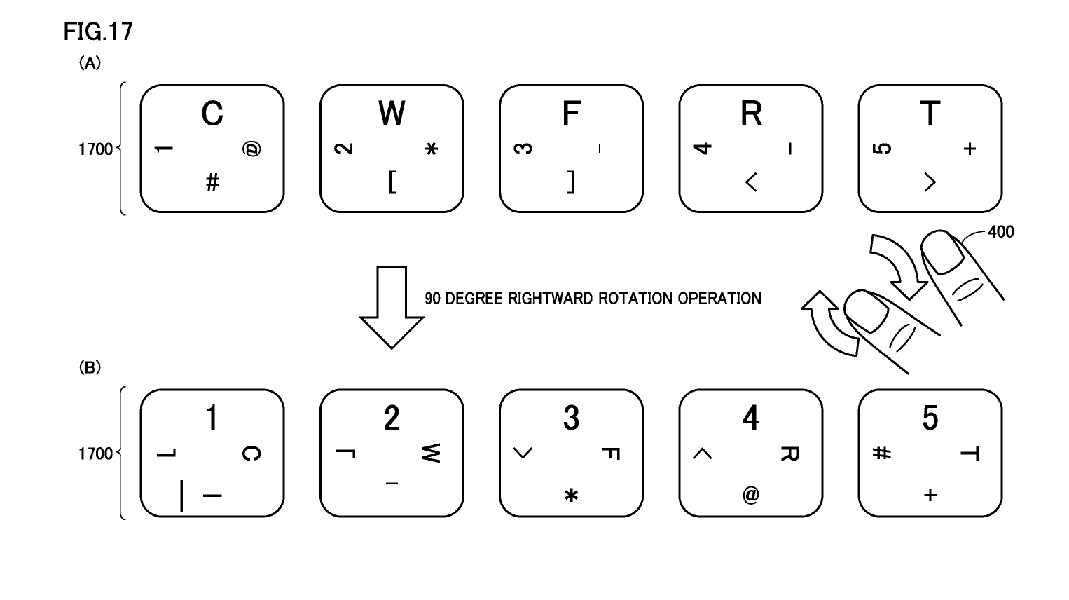

Referring to FIG. 17, another feature of the input device 100 according to the present embodiment will be described. FIG. 17 illustrates another manner of switching of display of a software key 1700.

Specifically, as shown in the state (A), in one aspect, the software key 1700 includes an approximately rectangular key. Each key is labeled with, for example, four characters or numbers or symbols. When the user performs an operation of rotating the finger 400 rightward 90 degrees while performing a touch operation in this state, the number is displayed in the normal arrangement so as to accept input of number, as shown in the state (B).

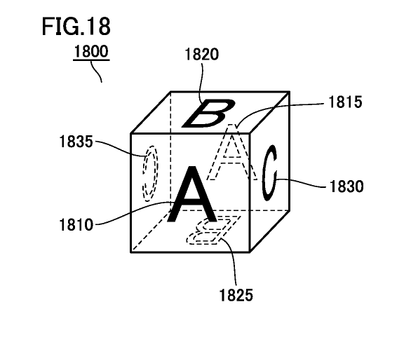

Referring to FIG. 18, another feature of the input device 100 according to the present embodiment will be described. FIG. 18 illustrates another manner of a software key 1800 appearing on the input device 100.

In one aspect, the software key 1800 displays a see-through cube. More specifically, the software key 1800 displays a face A 1810 on the front, a face B 1820 on the top, and a face C 1830 on the side. The software key 1800 is displayed translucently. In the software key 1800, characters, numbers, or symbols as input targets may also be allocated to faces 1815, 1825, 1835 located at places normally unseen.

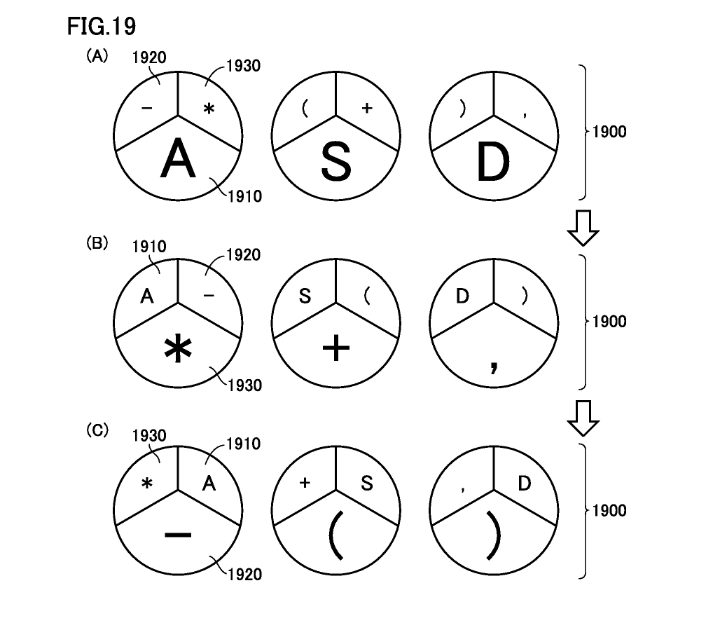

Referring to FIG. 19, another feature of the input device 100 according to the present embodiment will be described. FIG. 19 illustrates a manner in which a software key appearing on the touch panel 300 of the input device 100 is circular.

As shown in the state (A), in one aspect, the touch panel 300 displays a circular key 1900. The key 1900 includes, for example, regions 1910, 1920, 1930. The size of the region 1910 is larger than the other regions 1920, 1930. Here, the region 1910 is set active so as to accept input of a touch operation. When the user touches the region 1910 in the state (A), input of letter of alphabet A is accepted.

When the user makes a gesture of rotating clockwise on the touch panel 300 while touching it with the finger, the touch panel 300 displays the key in which the arrangement of character or symbol is changed as shown in the state (B). Specifically, the key 1900 displays the region 1930 at the center and displays the regions 1910, 1920 in a size smaller than the region 1930. When the user performs a touch operation in this state, input of the symbol * is accepted.

When the user further performs a rotation operation on the touch panel 300, the touch panel 300 displays the region 1920 at the center as shown in the state (C). The regions 1910, 1930 are displayed in a size smaller than the region 1920. When the user touches the region 1920 in this state, input of the symbol - is accepted.

The circular shape of the key in this manner easily conveys the image of rotation to the user. Since the characters and symbols allocated to the keys are displayed in the same direction, the user can easily recognize the character, number, or symbol allocated to each key.

The switching of input modes is not limited to a rotation operation. For example, the region to be active may be switched by a pressing time. For example, if the region 1910 is active in the state (A), the user may press and hold the region 1920 or 1930. In this case, the pressed and held region is switched from the non-active state to the active state, and the number or symbol allocated to the pressed and held region may be displayed in place of the region 1910. Such a configuration allows the user to intuitively grasp the switching of input modes thereby improving the operability.

[Hardware Configuration]

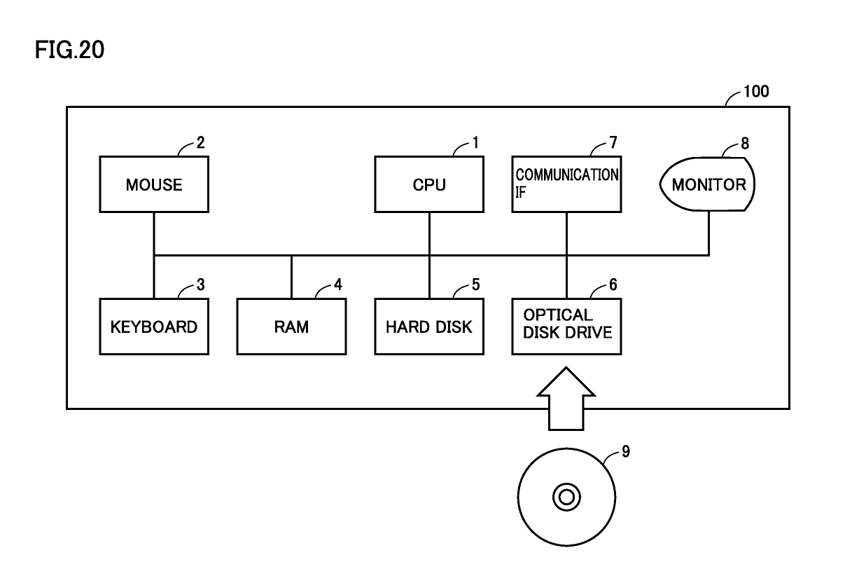

An example of the hardware configuration of the input device 100 according to the present embodiment will be described with reference to FIG. 20. FIG. 20 is a block diagram illustrating the hardware configuration of the input device 100. In one aspect, the input device 100 is implemented using a computer having a well-known configuration.

More specifically, the input device 100 includes, as main components, a CPU (Central Processing Unit) 1 executing a program, a mouse 2 and a keyboard 3 accepting input of an instruction by the user of the input device 100, a RAM 4 storing data generated by execution of a program by the CPU 1 or data input through the mouse 2 or the keyboard 3 in a volatile manner, a hard disk 5 storing data in a nonvolatile manner, an optical disk drive 6, a monitor 8, and a communication IF (interface) 7. The components are mutually connected through a bus. A CD-ROM 9 or any other optical disk is attached to the optical disk drive 6. The communication IF 7 includes, but not limited to, a USB (Universal Serial Bus) interface, a wired LAN (Local Area Network), a wireless LAN, and a Bluetooth® interface.

The processing in the input device 100 is implemented by the hardware of the input device 100 and the software executed by the CPU 1. Such software may be stored in the hard disk 5 in advance. The software may be stored in a CD-ROM 9 or any other computer-readable nonvolatile data recording media and distributed as a program product. Alternatively, the software may be provided as a downloadable program product by an information provider connected to the Internet or other networks. Such software is read from a data recording medium by the optical disk drive 6 or other data reader or downloaded through the communication IF 7 and then temporarily stored into the hard disk 5. The software is read out from the hard disk 5 by the CPU 1 and stored into the RAM 4 in an executable program format. The CPU 1 executes the program.

Each component of the input device 100 shown in FIG. 20 is general. It can be said that the most essential part of the present embodiment lies in the program stored in the input device 100. The operation of the hardware of the input device 100 is well known, and a detailed description thereof will not be repeated.

The data recording medium is not limited to a CD-ROM, an FD (Flexible Disks), and a hard disk and may be a non-volatile data recording medium that fixedly carries a program, such as a magnetic tape, a cassette tape, an optical disk (MO (Magnetic Optical Disc)/MD (Mini Disc)/DVD (Digital Versatile Disc)), an IC (Integrated Circuit) card (including a memory card), an optical card, a semiconductor memory such as a mask ROM, an EPROM (Electronically Programmable Read-Only Memory), an EEPROM (Electronically Erasable Programmable Read-Only Memory), and a flash ROM.

The program referred to here may include not only a program directly executable by the CPU but also a program in a source program format, a compressed program, and an encrypted program.

[Configuration]

In one aspect, the monitor 8 of the input device 100 displays an image of each key that constitutes a keyboard and is labeled with information for identifying a plurality of operation modes. The input device 100 includes a touch panel for accepting an input operation on an image of the keyboard. Each key is set so as to accept an input in accordance with an operation mode of the input device 100. The CPU 1 is configured to, if an operation on the touch panel to indicate a predetermined direction is accepted, select an operation mode in accordance with the predetermined direction from the operation modes identified by the information labeled on each key and allow the monitor 8 to display the keyboard corresponding to the selected operation mode.

Preferably, the image of each key displayed on the monitor 8 includes an image in which a rectangular parallelepiped is displayed in a three-dimensional manner or an image in which a character, a number, or a symbol allocated to the key is displayed in a single key.

Preferably, the CPU 1 is further configured to change a display manner of other keys that constitute the keyboard displayed on the monitor 8 in connection with an operation on any each key.

Preferably, the operation modes include an input mode and a transmission mode.

Preferably, the input mode includes a character input mode, a symbol input mode, and a number input mode.

Preferably, an operation event when a touch operation on the touch panel is performed and an operation event when a gesture operation is performed while a touch operation is being performed are switchable.

Preferably, the image of each key is transparent or translucent. Of the faces of each key, the image allocated to the face located on the back side from a view point of the keyboard is displayed in reverse.

Preferably, each key displayed on the monitor 8 is capable of being rotationally displayed. The touch panel of the monitor 8 is configured to accept input depending on the position of each key after rotation.

### CONCLUSION

As described above, the input device 100 according to the present embodiment displays a software keyboard and, when an operation on the touch panel to indicate a predetermined direction is accepted, switches to an operation mode such as an input mode or transmission mode of the software keyboard, in accordance with the predetermined direction, from among a plurality of operation modes identified by information labeled on each key. The user of the input device 100 thus can switch operation modes with a simple operation, thereby improving the operability of the input device 100.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An input device having a plurality of operation modes, comprising:
a display unit configured to display an image of each key that constitutes a keyboard and is labeled with information for identifying the operation modes;
a touch panel configured to accept an input operation on an image of the keyboard,
the each key being set so as to accept an input in accordance with an operation mode of the input device; and
a controller configured to, when an operation on the touch panel to indicate a predetermined direction is accepted, select an operation mode in accordance with the predetermined direction from the operation modes identified by the information labeled on the each key and allow the display unit to display the keyboard corresponding to the selected operation mode.

2. The input device according to claim 1, wherein the image of each key displayed on the display unit includes an image in which a rectangular parallelepiped is displayed in a three-dimensional manner or an image in which a character, a number, or a symbol allocated to the key is displayed in a single key.

3. The input device according to claim 1, wherein the controller is further configured to change a display manner of other keys that constitute the keyboard displayed on the display unit in connection with an operation on any each key.

4. The input device according to claim 1, wherein the operation modes include one of an input mode and a transmission mode.

5. The input device according to claim 4, wherein the input mode includes a character input mode, a symbol input mode, and a number input mode.

6. The input device according to claim 1, wherein an operation event when a touch operation on the touch panel is performed in accordance with the operation mode and an operation event when a gesture operation is performed while the touch operation is being performed are switchable.

7. The input device according to claim 1, wherein the image of the each key is transparent or translucent, and, of faces of the each key, an image allocated to a face located on a back side from a view point of the keyboard is displayed in reverse.

8. The input device according to claim 1, wherein
the each key is configured to be capable of being rotationally displayed, and
the touch panel is configured to accept an input in accordance with a position of the each key after rotation.

9. An information processing apparatus comprising an input device recited in claim 1.

10. A method for controlling an input device including a touch panel and having a plurality of operation modes, the method comprising:
displaying an image of each key that constitutes a keyboard and is labeled with information for identifying the operation modes;
accepting an input operation on an image of the keyboard,
the each key being set so as to accept an input in accordance with an operation mode of the input device; and
when an operation on the touch panel to indicate a predetermined direction is accepted, selecting an operation mode in accordance with the predetermined direction from the operation modes identified by the information labeled on the each key and displaying the keyboard corresponding to the selected operation mode.

11. The method according to claim 10, wherein the image of each key displayed on the input device includes an image in which a rectangular parallelepiped is displayed in a three-dimensional manner or an image in which a character, a number, or a symbol allocated to the key is displayed in a single key.

12. The method according to claim 10, further comprising changing a display manner of other keys that constitute the keyboard displayed on the input device in connection with an operation on any each key.

13. The method according to claim 10, wherein the operation modes include one of an input mode and a transmission mode.

14. The method according to claim 13, wherein the input mode includes a character input mode, a symbol input mode, and a number input mode.

15. The method according to claim 10, wherein an operation event when a touch operation on the touch panel is performed in accordance with the operation mode and an operation event when a gesture operation is performed while the touch operation is being performed are switchable.

16. The method according to claim 10, wherein the image of the each key is transparent or translucent, and, of faces of the each key, an image allocated to a face located on a back side from a view point of the keyboard is displayed in reverse.

17. The method according to claim 10, wherein
the each key is configured to be capable of being rotationally displayed, and
the method further comprises accepting an input in accordance with a position of the each key after rotation.

18. A non-transitory data recording medium for storing a program for causing a computer to perform a method recited in claim 10.
